(19) United States
(12) Patent Application Publication
(10) Pub. No.: US 2008/0082511 A1
(43) Pub. Date: Apr. 3, 2008

(54) Methods for providing, displaying and suggesting results involving synonyms, similarities and others

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/897,667

(22) Filed: Aug. 31, 2007

Related U.S. Application Data
(60) Provisional application No. 60/841,780, filed on Aug. 31, 2006.

(51) Int. Cl. G06F 17/30

(52) U.S. Cl. 707/3

(57) ABSTRACT

A series of methods and systems for searching, providing, displaying and suggesting results of records comprising the conversion or transformation of synonyms and similarities to match the query's words are described. In one embodiment, results comprising synonyms and/or similarities of the query's word are displayed implementing the said word of the query, thus matching the user's language criteria and skill.

### RELATED APPLICATIONS

This is application claims the benefit of: provisional patent application Ser. No. 60/841,780 filed 2006 Aug. 31.

### BACKGROUND

1. Field of the Invention

The present invention relates generally to several methods for retrieving and providing information in general. More particularly, to a variety of methods for providing, displaying and suggesting results which involve the substitution of synonyms, similarities and others with the query's words and/or other more similar words.

2. Description of Related Art

The revolution of the Internet has awakened several new search engine technologies, markets for ecommerce and needs for its users, sellers and providers. Current search engine technology provides many valuable features directed to assist the users finding the items they are looking for. However, the complexity of many words and languages still portray many difficult barriers to current search engines to overcome. For example, synonyms and similarities can quickly cripple the results and sales for ecommerce. Items with several nomenclatures can be difficult or sometimes impossible to find, limiting sales, sellers, and buyers. Even when a Synonym capable search engine is used, the different nomenclatures of the item may compromise its position on the result's display and then its relevance. Furthermore, the results may not necessarily fit or match the buyer's language skill, criteria, or comfort. As result, the possibility of risking the sale and the buyer are very real, and potentially damaging. For example, a possible buyer enters the words “fuser roller” and proceeds to search. The results display some records using the words “fuser roller” and others using the words “fixing roller” which also identified the same product. Unfortunately, the chances for the “fixing roller” item to be sold are smaller than those items matching the exact and identical language criteria of the buyer. In addition, the buyer's educational and language skill may unwarily identify the item as a different and erroneous product, thus removing its chances for sale.

In view of the present shortcomings and limitations, the present invention distinguishes over the prior art by providing heretofore a broader and more compelling method to provide searched results to the user implementing or better matching his/her language skill while providing additional unknown, unsolved and unrecognized advantages as described in the following summary.

### SUMMARY OF THE INVENTION

The present invention teaches certain benefits in use and construction which give rise to the objectives and advantages described below. The methods embodied by the present invention overcome the limitations and shortcomings encountered when searching and providing results that utilize other nomenclatures (synonyms) or other words with similar meanings. The present invention discloses a series of methods for displaying, providing, and suggesting said searched information capable of being identified through several forms of nomenclatures by implementing identical or more similar nomenclatures as employed by the user.

### OBJECTS AND ADVANTAGES

A primary objective inherent in the above described method of use is to provide a means and methods for displaying retrieved information not taught by the prior arts and further advantages and objectives not taught by the prior art. Accordingly, several objects and advantages of the invention are

Another objective is to improve ecommerce applications comprising items and information using several nomenclatures.

Another objective is to aid the user to identify matching searched results.

Another objective is to provide information in familiar and similar language and skill of the user.

Another objective is to familiarize users with other nomenclatures used by the searched information.

A further objective is to allow control to at least one of a: user, search engine and website to implement the substitution of synonyms and other similar type information.

A further objective is to provide a better formatting for information display.

A further objective is to deal with equally valuable information in a equal manner.

A further objective is to enable websites and information providers to utilize any type of synonym or similar information to identify the item regardless of the skill of the clientele.

A further objective is to permit superior searching accuracy.

A further objective is to permit searches of archaic information implementing connotative language.

A further objective is to suggest better search queries and results.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 is a non-limiting block diagram of the main steps of the most general inventive method;

FIG. 2 is a non-limiting block diagram of an exemplary results display of the most general inventive method;

FIG. 3 is a non-limiting block diagram of the inventive method working in association with a multiplex querying search engine;

FIG. 4 is a non-limiting block diagram of the inventive method incorporated by a group identifier search engine;

FIG. 5 illustrates a general and exemplary non-limiting block diagram of the inventive method displaying results in association by a concept numeric based search engine;

FIG. 6 is a non-limiting illustration of a variation for displaying converted information of the inventive method;

FIG. 7 is a non-limiting illustration of an exemplary display of converted and non-converted records of the inventive method;

FIG. 8 is a non-limiting illustration of a converting control interface available to a user;

FIG. 9 illustrates a non-limiting example for displaying similarities;

FIG. 10 is a non-limiting illustration of an exemplary variation of a method for displaying information suggesting a query's word;

FIG. 11 is a non-limiting illustration of another variation implementing suggestions for searching information.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

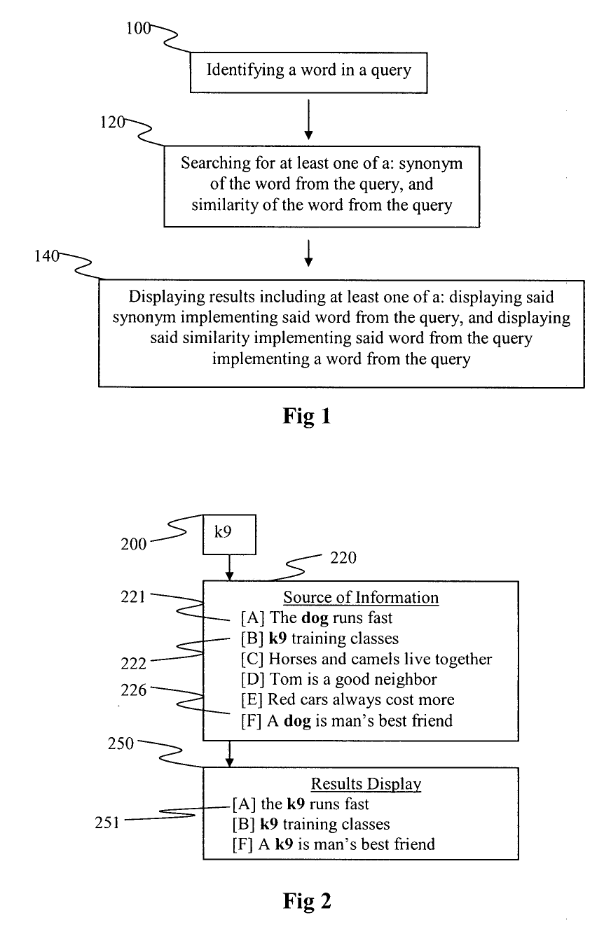

FIG. 1 illustrates a non-limiting block diagram of the main steps of the inventive method. The initial step 100 (FIG. 1) involves the obvious step of identifying a word in a query for identifying any other information identifying the same or similar concept, such as a synonym per se. The next step 120 (FIG. 1) involves finding at least one of a: synonym of a word from the query, and similarity of a word from the query. The final step 140 (FIG. 1) involves displaying at least one of a: said synonym implementing a said word from the query, and said similarity implementing a said word from the query. In other words, displaying the results substituting the synonym or similarity found on the original record with the word (querying synonym or querying similarity) used in the query.

FIG. 2 illustrates a non-limiting block diagram of an exemplary display of searched information of the general inventive method. The query 200 (FIG. 2) comprising the word “k9” is searched on the Source of Information 220 (FIG. 2) which contains records [A] through [F]. By examining the Source of Information, it becomes visible that only record [A] 221 (FIG. 2), record [B] 222 (FIG. 2) and record [F] 226 (FIG. 2) contain the word “k9” and/or synonyms such as the word “dog.” Current search engines display the results including those words exactly as present or found in the Source of Information, that is, record [A] and record [F] are displayed using the word “dog” and record [B] is displayed using the word “K9.” However, in the Results Display 250 (FIG. 2) of the inventive method, the matching records [A], [B] and [F] are all displayed implementing the same word “k9” as used by the client or query. For example, in the Source of Information 220 (FIG. 2), record [A] 221 (FIG. 2) is using the word “dog,” yet in the Results Display 250 (FIG. 2), the resulting record [A] 251 (FIG. 2) is now using the word “k9” like its query 200 (FIG. 2). In other words, matching search results are displayed implementing the words used by the client or query. In such fashion, it may be said that the results were “mutated” or “converted” to match the client's language skill or other.

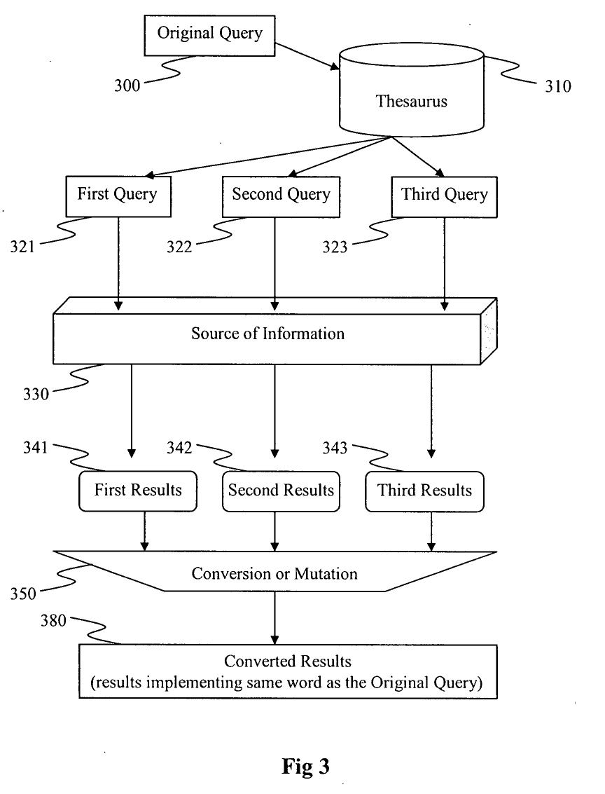

FIG. 3 is a non-limiting block diagram of the inventive method being incorporated by a multiplex type search engine. In a multiplex type search engine, the words from the query are identified and compared to a thesaurus. If the query's word has synonyms or similarities, several searches will be executed, each involving a particular synonym or similarity for producing the final results. Consequentially, the original query 300 (FIG. 3) is compared or analyzed toward a thesaurus 310 (FIG. 3) identifying 3 synonyms, therefore creating or forming 3 different queries such as the first query 321 (FIG. 3), the second query 322 (FIG. 3) and third query 323 (FIG. 3). Each of these three queries is used to search the Source of Information 330 (FIG. 3) for their matching results, thus producing three groups of outcomes such as the First Results 341 (FIG. 3), the Second Results 342 (FIG. 3) and the Third Results 343 (FIG. 3). In the next converting step 350 (FIG. 3), each of the groups of results is converted or mutated. Finally, the Converted Results 380 (FIG. 3) from all three separate searches are displayed implementing the word entered in the original query 300 (FIG. 3).

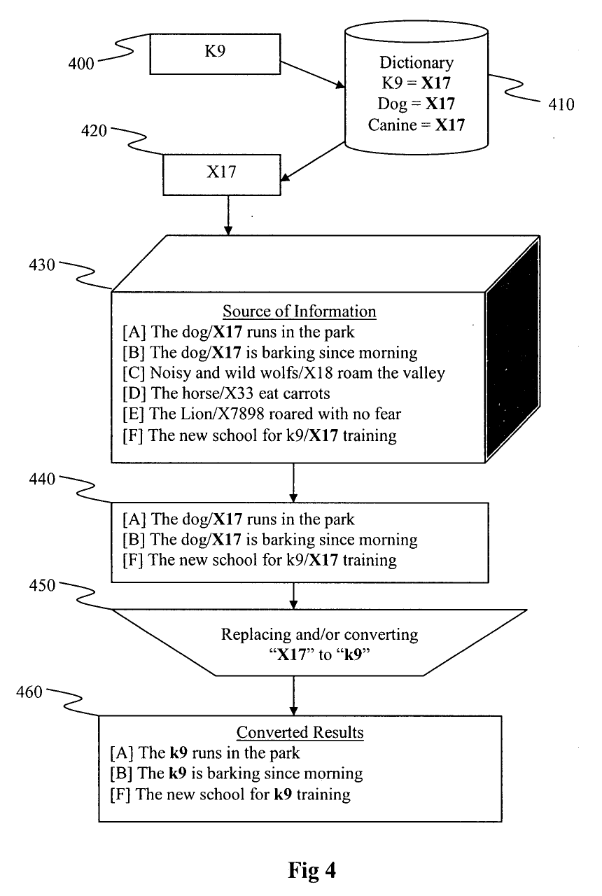

FIG. 4 is a non-limiting block diagram of the inventive method being incorporated by a group identifier search engine. A group identifier search engine implements an information or identifier to describe a group of words. In such fashion, the query and the Source of Information all utilized the identifier to retrieve and produce searched results, ultimately displaying the words present in the Source for Information. However, the disclosed inventive method modifies how information is produced. For example, the entry query 400 (FIG. 4) containing the word “k9” is identified or modified by the dictionary 410 (FIG. 4), resulting in the new identifier query 420 (FIG. 4) containing the identifier “X17.” Then, the search for “X17” is executed upon the Source of Information 430 (FIG. 4) which also contains the identifier “X17.” Those records matching the identifier query criteria (X17) are retrieved as shown by the pre-results table 440 (FIG. 4). Then the converting and/or filtering step 450 (FIG. 4) removes and replaces both, the identifier “X17” and its corresponding word in the record, with the word “k9” from the entry query 400 (FIG. 4). The final results 460 display the converted records implementing the word “k9” exclusively. Noteworthy, the conversion or substitution of word elements may occur even when said substitution involves identical word elements, such as replacing the word “k9” in the Source of Information, with the word “k9” from the entry query. Noteworthy, a variation of the identifier search engine method involves only searching for synonyms of the query and then producing such results implementing the query's word(s).

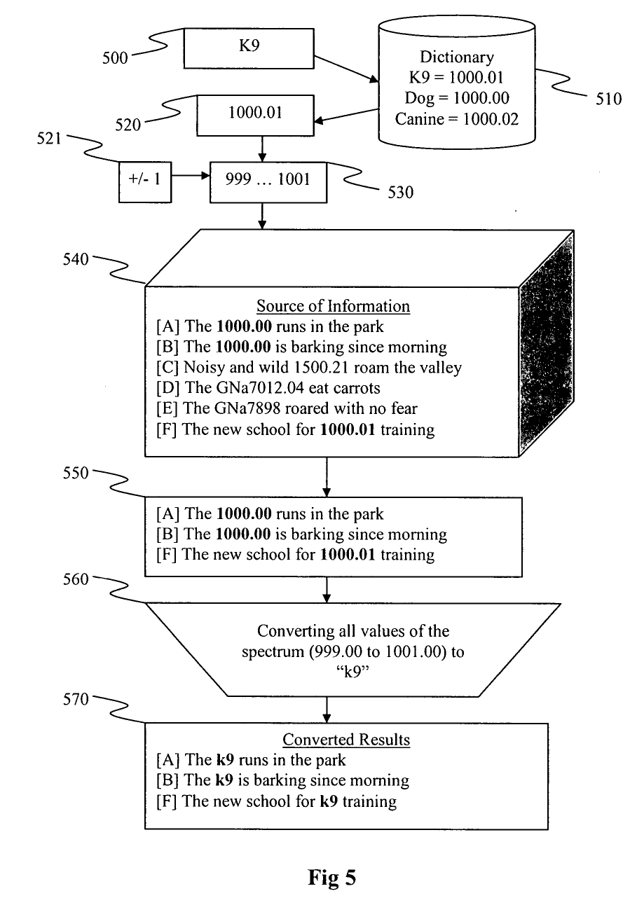

FIG. 5 illustrates a general and exemplary block diagram of the inventive method displaying results implementing a concept numeric based search engine. A concept numeric search engine substitutes words with values while grouping and arranging synonyms and other similar information in neighboring number areas, which can later be associated through numeric control for including said synonyms and similarities on searches and retrieval operations. In FIG. 5 the entry query 500 (FIG. 5) comprising the word “k9” is identified by the dictionary 510 (FIG. 5) and is then converted to the numeric query 520 (FIG. 5). The numeric search modifier 521 (FIG. 5) modifies the numeric query and transforms it to the new spectrum query 530 (FIG. 5) which is used to search and retrieve data from the Source of Information 540 (FIG. 5). The pre-results table 550 (FIG. 5) illustrates the retrieved records. Then, the converting step 560 (FIG. 5) converts the records for finally producing the converted results 570 (FIG. 5).

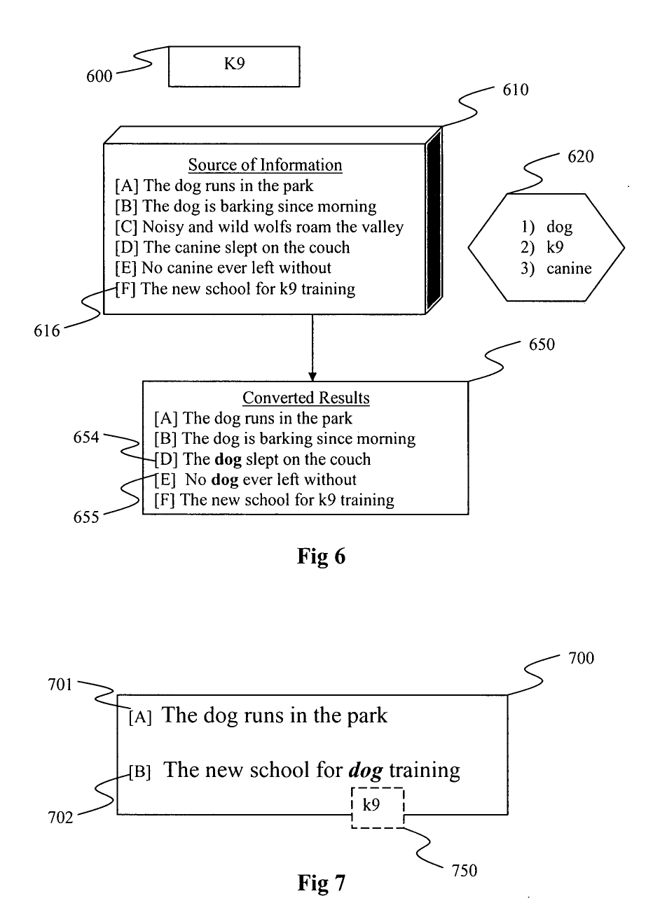

FIG. 6 is a non-limiting illustration of a variation for displaying converted information of the inventive method. The entry query 600 (FIG. 6) comprising the word “k9” is searched in the Source of Information 610 (FIG. 6). Only Record [F] 616 (FIG. 6) utilizes the same word element. On the other hand, the Frequency Word Table 620 (FIG. 6) identifies the word “dog” to be the displaying word of choice. As a result, all records having synonyms or similarities of the word “k9” will be converted to the primary word of choice. In other words, all those records not using the word “k9,” but using other synonyms or similarities of “k9” will be displayed using other more suitable words such as the primary word of choice which in this example is the word “dog.” The Converted Results 650 (FIG. 6) illustrates such a conversion by displaying record [D] 654 (FIG. 6), and record [E] 655 (FIG. 6) implementing the word “dog” as stated by the Frequency Word Table 620 (FIG. 6) and not the Source of Information 610 (FIG. 6).

FIG. 7 is a non-limiting illustration of an exemplary display of several converted and non-converted records. The display or results window 700 (FIG. 7) contains two retrieved records. In the first or [A] record 701 (FIG. 7), all the words or text appears to be uniform in shape and color. However, in the second or [B] record 702 (FIG. 7), the word “dog” appears in bold and italic, identifying that the word “dog” is a converted word. Optionally, simply by positioning the computer's cursor above the word “dog” of record [B] 702 (FIG. 7), produces the True Word Window 750 (FIG. 7) displaying or identifying the real word used in the Source of Information. Noteworthy, other forms of actions such as right clicking the converted word may also produce the True Word Window and/or activate other kinds and types of search and display controls such as color of converted text, etc.

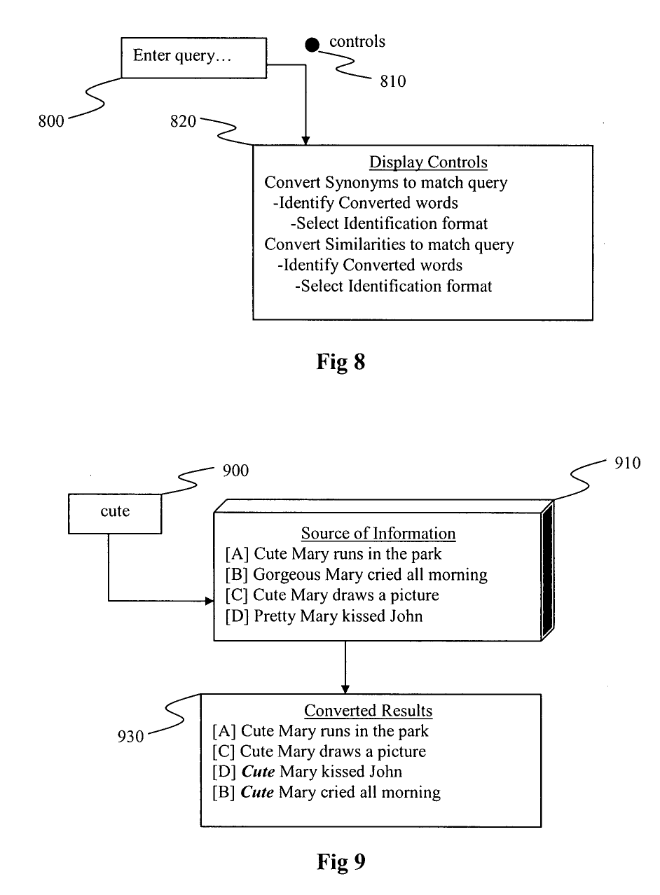

FIG. 8 is a non-limiting illustration of a converting control interface available to a seeking controlling entity such as a user, website or search engine. Next to the entry query field 800 (FIG. 8) is a circular image 810 (FIG. 8) for identifying controls to display information. Clicking the circular image 810 (FIG. 8), displays the Display Control Window 820 (FIG. 8) comprising a menu for selecting the type of configuration displayed desired. Noteworthy, the display controls can be accessible to a variety of entities each having its own controls and priority levels. For example, the user's choice may override the website producing the results which ultimately overrides the Internet search engine in charge of executing the searches. Another noteworthy feature is the capability of the search engine to host a variety of custom and personalized setting to accommodate each user and/or group of users. For example, in a household, two different people have different and preferred choices to search, retrieve, suggest, and display retrieved information, such as including or excluding synonyms, enforcing directional conceptuality on results, display mutated or converted words in red, etc. In addition, the search engine may optionally identify the user by means of any type of information entry or display, such as greeting the user with his/her name for identifying the search behavior to be implemented and/or identifying an entry from a selection menu presented to the user to identify him/herself by name, etc. Further additional methods such as personal passwords and others can allow supplementary and/or more precise identification methods. Furthermore, advancements of the disclosed inventive method and its disclosed variations, permit storing search and querying information associated to each user or group of users. In such fashion, user profiles can be build for better understanding the user's topics of interest, informational preferences, searches, needs, language skill, and even education.

Another noteworthy attribute of the inventive methods concerns the ranking of results, since prospectively all conceptually matching retrieved data utilizes the same words as the entry query. In such fashion mutated records could be ranked equally or differently than non-converted records. In addition, special attention can be given to similarities. Similarities are words that independently identify a particular intensity of the concept they bestow in general. For example, the words cute, pretty, beautiful and gorgeous, are similarities since each word independently identifies a specific intensity of the general concept of “beauty.” In such fashion, results comprising similarities with a more similar conceptual intensity to that of the query can be displayed closer to those records using the same words as the query; and those records implementing similarities that are more distantly intense or similar to the word of the query can be provided or displayed toward the end of the list of results or can be given lesser ranking. FIG. 9 illustrates a non-limiting example for displaying similar information. The entry query 900 (Fig) for the word “cute” is searched in the Source of Information 910 (FIG. 9). Although all records are displayed implementing the word “cute,” those records with the original word “gorgeous” will be display further away than those records that were implementing the words “cute” and “pretty” in the Source of Information. The Converted Results 930 (FIG. 9) illustrates such a hierarchy display, wherein the order of the records [A] through [D] was changed to [A], [C], [D] and [B] respectively.

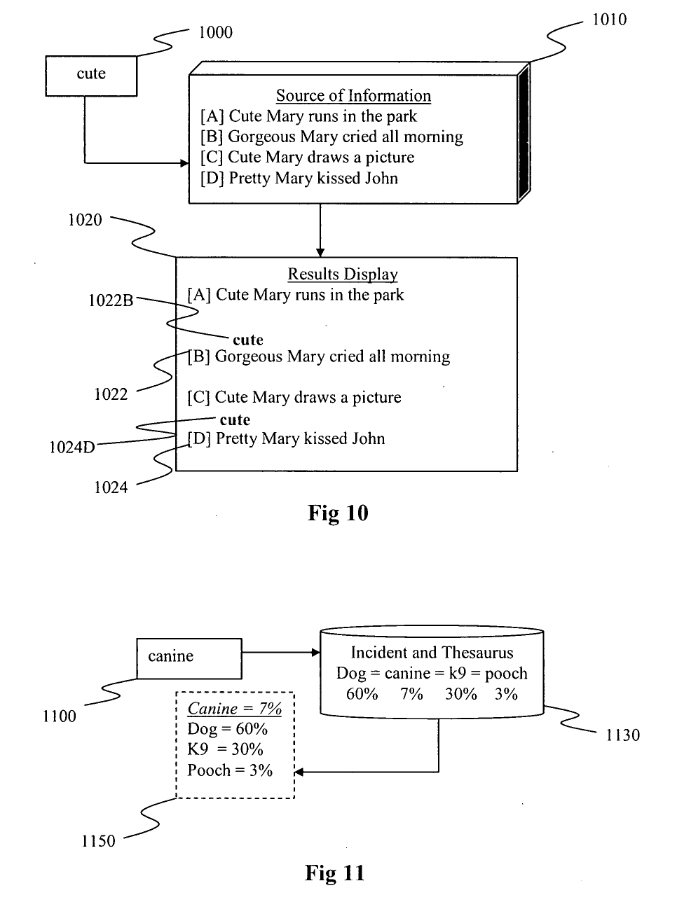

FIG. 10 is a non-limiting illustration of an exemplary of a method for displaying information suggesting a query's word. In this variation of the method, the results are not converted or mutated to match the words from the query, but rather the words of the entry query are displayed in neighboring areas to their synonyms and/or similarities displayed in the results. For example, the entry query 1000 (FIG. 10) is searched in the Source of Information 1010 (FIG. 10) for displaying the Results Display 1020 (FIG. 10). As illustrated in the Results Display 1020 (FIG. 10) the retrieved records still contain or illustrate the original words they have or use in the Source of Information. However, resulting record [B] 1022 (FIG. 10) illustrates its suggestive information 1022B (FIG. 10) just above the word “gorgeous” suggesting the word “cute” that was implemented in the query 1000 (FIG. 10). In similar fashion, resulting record [D] 1024 (FIG. 10) is using the same words present in the Source of Information, with the addition of its respective suggesting word of “cute” 1024D (FIG. 10).

FIG. 11 is a non-limiting illustration of another variation implementing suggestions for searching information. In this variation of the inventive method, the entry query is analyzed for synonyms and similarities. As a result, suggestive words are displayed announcing the user of other prospective words and/or possible searches. For example, in FIG. 11, the entry query 1100 (FIG. 11) comprising the word “canine” is analyzed or searched for any synonyms and/or similarities against the Incident and Thesaurus 1130 (FIG. 11). As a result, synonyms for the word “canine” are found and displayed in the suggestive table 1150 (FIG. 11) announcing the user of other similar type words. Furthermore, the suggestive word table 1150 (FIG. 11) also displays other valuable information such as the incident percentage of each synonym of the word “canine.” For example, the suggestive Table 1150 (FIG. 11) announces that “dog” is used 60%, in comparison to the word “k9” which is used 30% of the times. The word “pooch” is hardly ever used (3%), and the word implemented by the user, “canine” (on top) is used or is present in 7% of all records. Noteworthy, the percentage incident can be a calculation from other sources other than the statistics of the Source of Information. For example, the word “dog” is used by 70% of all records, yet the information at hand, indicates 60%, thus displaying 60% as the value for “dog.” In addition, the values it displays can be of different relating nature such as “dog=800%” or “dog” is used 8 times more commonly used than the word “canine,” etc.

Noteworthy, entry queries can be originated from any type of information seeking entity such as a human, program, and machine. In similar manner, the ensuing results can be provided to either of those entities.

Noteworthy, word group identifiers which are here referred to as “alphanumeric points” and others of inferior associative scope and capabilities such as those identifiers found in a thesaurus can ultimately interrelate, interfere and/or associate with each other(s) for many intent purposes such as replacing, alternating, modifying, reducing, increasing, manipulating, translating, and standardizing their different scopes, sizes, styles, information and associative capabilities. Searching and retrieving utilizing such alphanumeric points, whether they come from a first or latter identifying steps, allows finding results beyond textual representation searches or even synonymous searches.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a series of novel methods for producing, displaying and suggesting search information can be appreciated. The described methods overcome the conceptual limitations encountered current search engine displays and results by providing superior results to match the user's criteria and skill, while improving ecommerce applications.

1. A method for displaying retrieved information comprising the steps of:
a) Identifying a word in a query;
b) Searching for an information including at least one of a: information identifying the same concept of a said word such as a synonym, and information identifying a similar concept of said word such as a similarity;
c) Displaying results implementing said word.
